(19) United States
(12) Patent Application Publication
(10) Pub. No.: US 2014/0207568 A1
(43) Pub. Date: Jul. 24, 2014

(54) BIASING SELECTION OF ADVERTISING BASED ON REAL-TIME USER INTERACTIONS IN A SOCIAL NETWORKING SYSTEM

(71) Applicant: Facebook, Inc., Menlo Park, CA (US)

(72) Inventors: Giridhar Rajaram, Cupertino, CA (US); Rong Yan, Mountain View, CA (US)

(21) Appl. No.: 13/749,358

(22) Filed: Jan. 24, 2013

(51) Int. Cl. G06Q 30/02; G06Q 50/00

(52) U.S. Cl. CPC G06Q 30/0251; G06Q 50/01
USPC 705/14.49

(57) ABSTRACT

A social networking system receives advertisement requests from advertisers describing information about advertisements and determines one or more ad topics associated with the advertisements. When an advertisement is to be presented to a user, the social networking system determines one or more topics associated with the user from actions performed by the user and identifies candidate advertisements having ad topics matching, or similar to, the topics associated with the user. The topics associated with the user may be determined based on the user's most recent actions. One or more of the candidate advertisements are selected for presentation to the user.

### BACKGROUND

This invention relates generally to social networking systems, and in particular to selecting an advertisements for presentation to social networking system users.

Social networking systems allow users to establish connections to other users and exchange information with each other. For example social networking system users may exchange content items with each other, generate content distributed by the social networking system to additional users, or perform other actions. Social networking systems leverage the connections among their users to provide more relevant information to each user in view of user-specific interests.

Advertisers have attempted to leverage information about social networking system users by using information from social networking systems to target advertisements (“ads”) to different users. Presentation of advertisements also provides revenue to the social networking system, which may select an ad for presentation to a user from a group of candidate ads. For example, when a user has a characteristic satisfying targeting criteria associated with ads, the ads having targeting criteria, which specify one or more characteristics of users eligible to be presented the ads, satisfied by the user are the group of candidate advertisements for the user. Each ad is associated with a bid amount, which indicates the amount of compensation the social networking system receives for presenting the an ad to a user, based on the bid amounts of the candidate ads and information about the user, the social networking system selects and ad for presentation to the user that maximizes the revenue to the social networking system.

However, when selecting advertisements for users, static information about the user maintained by the social networking system may be inadequate to identify topics currently of interest to the user. This may reduce the likelihood of a user interacting with an advertisement selected for the user based on static criteria, reducing the value to the social networking system of the advertisement selected based on static criteria. Accordingly, selecting advertisements for social networking system users based on static user information reduces the advertising revenue available to a social networking system.

### SUMMARY

A social networking system receives information from advertisers describing a plurality of advertisements and extracts topics from the received advertisements. From the extracted topics, the social networking system generates a topic index associating advertisements with topics. Actions perform by a user are logged by the social networking system and analyzed to identify topics likely of relevance to the user. To present an advertisement to the user, the social networking system accesses the topic index to select candidate advertisements associated with the topics identified for the user.

Bid values associated with each of the selected candidate advertisements are retrieved and used to generate expected values for each of the selected candidate advertisements. In one embodiment, the expected value is based on the likelihood that the user accesses the candidate advertisement. The number of topics associated with a candidate advertisement matching the topics identified for a user may be used to determine the likelihood of the user accessing the candidate advertisement. Based on the expected values, the social networking system selects an advertisement from the candidate advertisements and presents the selected advertisement to the user. Inferring topics of interest for the user based on user actions and selecting advertisements based at least in part on the inferred topics increases the likelihood that the user will interact with a presented advertisement, which increases the value to the social networking system generated by presenting the advertisement.

### BRIEF DESCRIPTION OF THE DRAWINGS

FIG. 1 is a block diagram of a system environment including a social networking system, in accordance with one embodiment.

FIG. 2 is a block diagram of an ad targeter, in accordance with one embodiment.

FIG. 3 is a flow chart of a process for selecting an advertisement for display to a user, in accordance with one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Overview

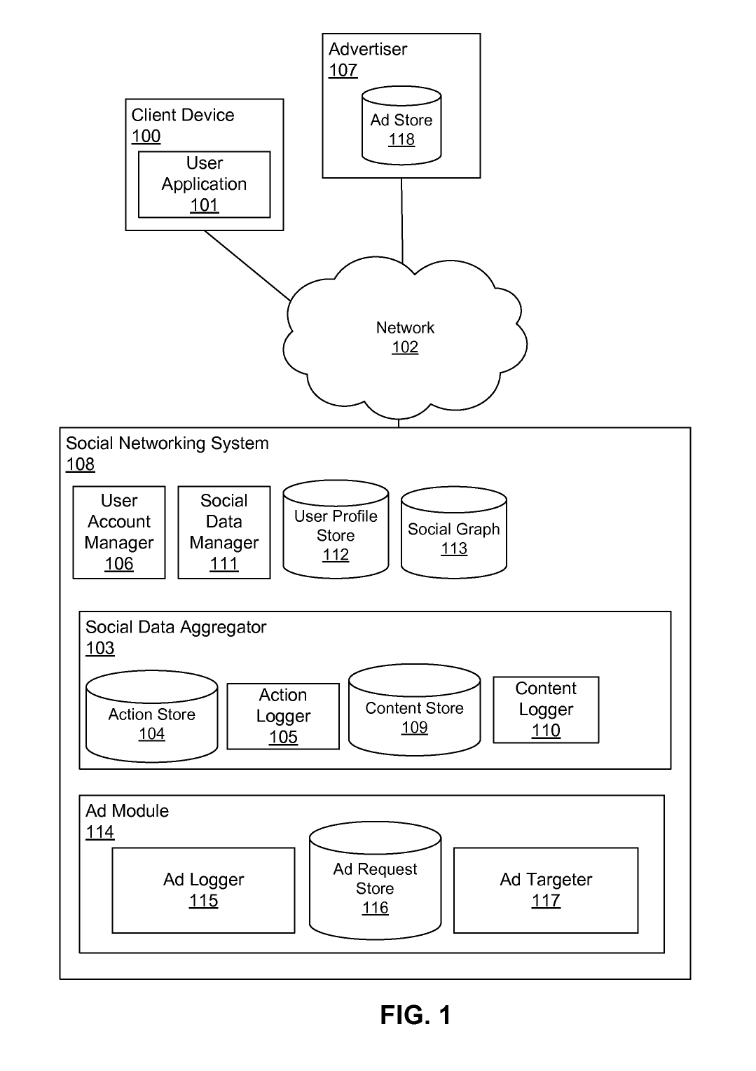

FIG. 1 shows a block diagram of one embodiment of a system environment including a social networking system 108. In the example shown by FIG. 1, the system environment includes a social networking system 108 connected to one or more client devices 100 and one or more advertisers 107 via a network 102. In other embodiments, the system environment may include different and/or additional components than those shown by FIG. 1.

The network 102 enables communications between the client devices 100, the advertisers 107, and the social networking system 108. In one embodiment, the network 102 uses standard communications technologies and/or protocols. Examples of communications technologies used by the network 102 include Ethernet, 802.11, worldwide interoperability for microwave access (WiMAX), 3G, 4G, LTE, digital subscriber line (DSL), asynchronous transfer mode (ATM), InfiniBand, PCI Express Advanced Switching, etc. In one embodiment the network 102 is the Internet.

The social networking system 108 stores data associated with users and allows users to communicate and interact with each other. For example, the social networking system 108 allows a user to establish an account and a user profile. Users of the social networking system 108 also establish connections with other social networking system users. The users connected to a user may be referred to as the user's “connections” or “friends.” The social networking system 108 may present information to a user about other users connected to that user via a newsfeed, profile page, or other interface. Users may create messages or upload content to be presented to other users through the social networking system 108.

When a user performs actions via the social networking system 108, the social networking system 108 may send a notification of the action to other users connected to the user performing the actions. Examples of actions include uploading data to the social networking system 108, posting a message to a profile page, posting content to another page of the social networking system 108, checking in at a location, operating an application, making a purchase online or offline, or any other suitable type of interaction. A description of each user's activities may be logged by the social networking system 108 as action data, which may be stored and associated with the user performing the actions. Based on action data associated with a user, the social networking system 108 may infer topics of interest to the user at various times.

The social networking system 108 also receives advertisement requests (“ad requests”) from the advertisers 107 that identify an advertisement for presentation to users of the social networking system, a bid and determines the relationship between these advertisements and various ad topics. Based on the current topics relevant to users, and the known ad topics for advertisements, the social networking system 108 is able to select targeted advertisements that are relevant for users at a given time. The social networking system 108 may present these selected targeted advertisements to users in conjunction with other social networking data.

A client device 100 is a computing device capable of processing data as well as transmitting and/or receiving data via the network 102. Examples of client devices 100 include mobile phones, desktop computers, laptop computers tablet computers, or other suitable devices. The client device 100 may host one or more user applications 101 allowing a user operating a client device 100 to exchange data with the social networking system 108. A user application 101 may be a web application comprising hypertext markup language (HTML) and JAVASCRIPT® code executing in a web browser, a native application executing on an operating system of the client device 101 (e.g., IOS® or ANDROID™), or any other suitable application format.

Advertisements may be selected by the social networking system 108 and presented to the use via the user application 101. For example, the user application 101 presents content from the social networking system 108 including one or more advertisements. Examples of content presented by the social networking system 108 that may include advertisements include a newsfeed, a profile page, messages, or other suitable types of communications. A user may interact with a presented advertisement to request additional information from the social networking system 108, or an advertiser 107, related to the advertisement. For example, accessing the advertisement retrieves a landing page associated with the advertisement including content presented to the user via the client device 100.

An advertiser 107 is an entity hosting advertisement content promoting goods and/services provided by entities. Examples of advertisers 107 include advertising agencies, advertising networks, retailers, or similar entities. As described above, an advertiser 107 may provide one or more advertisement requests to the social networking system 108 to present advertisements to social networking system users. In various embodiments, the social networking system 108 may retrieve advertisements for presentation to users from an advertiser 107 or the client 100 receives content from the advertiser 107 directly and presents the received content to users. The advertiser 107 may maintain an archive of advertisements in the ad store 118.

In the embodiment shown by FIG. 1, the social networking system 108 comprises a social data aggregator 103, a user account manager 106, a social data manager 111, a user profile store 112, a social graph 113, and an advertisement (“ad”) module 114. However, in other embodiments, the social networking system 108 may include different and/or additional components than those shown by FIG. 1.

The user account manager 106 receives information from a user to establish an account with the social networking system 108. Additionally, the user account manager 106 confirms a user's identity when the user subsequently connects to the social networking system 108. Information provided by a user to the social networking system 108 is stored in a corresponding user profile maintained in the user profile store 112. The user account manager 106 may generate a unique identifier for each user that establishes an account with the social networking system 108, and this identifier may be associated with a user's user profile.

The social data manager 111 receives data describing connections between users and other users and/or objects in the social networking system 108. Examples of objects maintained by the social networking system include content uploaded by users, events, locations, music, movies, or other information. Objects are stored in the social data manager 111 and may have different types. Examples of types of objects included in the social data manager 111 include photo objects, location objects, or other suitable data.

Objects or users may have one or more connections to other objects or users. The social data manager 111 stores information describing a connection as an edge. For example, a user may have a number of edges connected to photo objects including images of that user. In this example, the edges having a type indicating that the user is included in the images. Similarly, location objects may also be connected to photo objects by edges indicating the photos were taken at the locations.

The user profiles, objects and edges stored by the social networking system 108 may form an interconnected graph, or a social graph 113, describing users, objects and the connections between objects and/or users. In various embodiments, the social networking system 108 maintains the data describing the social graph 113 in one or more storage devices. The social graph 113 includes nodes representing objects and users, with the nodes connected by the edges representing the relationships between various objects and/or users. By traversing edges between nodes, the social data manager 111 identifies relationships between objects and/or users. For example, if the social data manager 111 receives a request for photos of a user at a particular location, the social data manager traverses the social graph 113 to identify photo objects that are connected to the user's user profile by edges indicating the user is represented in the photo objects and are also connected to the location object of the identified location by an edge indicating that the photo was taken at the location.

The social data aggregator 103 receives requests for information from a client device 100, determines information relevant for a user identified by a request, and sends the determined information to the client device 100. The social data aggregator 103 also receives data from users including uploaded content. Examples of uploaded content include photos, videos, text messages, check-ins, reviews, instant messages, links, or other data. The data received from the users implicitly and explicitly provides information to the social data aggregator 103 describing actions performed by users. Based on information describing actions performed by a user, the social data aggregator 103 identifies content relevant for the user. Additionally, in some embodiments, data about actions performed by users may be accessed by other components of the social networking system 108, such as the ad module 114.

In the embodiment shown by FIG. 1, the social data aggregator 103 comprises an action store 104, an action logger 105, a content store 109, and a content logger 110. The content logger 110 receives content, such as photos, videos, messages, and other data, from users and communicates the content to the content store 109 for storage. The content logger 110 may generate an identifier for each stored item of content. In one embodiment, the content logger 110 also notifies the social data manager 111 when new content is received, allowing the social graph 113 to be updated to include a node representing the new content as well as one or more edges to the user that uploaded the content, to users associated with the content, to locations associated with the content, or to other objects associated with the content. This allows the social graph 113 to be updated as the social networking system 108 receives additional content.

The action logger 105 processes communications from client devices 100 to generate action data describing actions identified from the communications. Generated action data is stored in the action store 104 as various entries. An entry of action data describes a performed action, a reference to the user that performed the action, a date when the action was taken or captured by the action logger 105, and one or more references to other users or objects associated with the action. For instance, if a user, John Smith, uploads a photo to the social networking system 108 in which another user, Jane Doe, is tagged, an entry of action data describing this action includes one or more of: text or binary data indicating that John Smith has taken a photo of Jane Doe, a reference to the object representing John Smith in the social graph 113, a reference to the object representing Jane Doe in the social graph 113, a reference to an object in the social graph 113 indicating the location where the photo was taken, a reference to the photo stored in the content store 109, a reference to the object representing the photo in the social graph 113, and a date when the photo was taken.

The ad module 114 receives advertisement requests from the advertisers 107 and selects advertisements to be sent to client devices 100 from the received advertisement requests (“ad requests”). In the embodiment shown by FIG. 1, the ad module 114 comprises an ad logger 115, ad request store 116, and ad targeter 117. The ad logger 115 receives ad requests from one or more advertisers 107 and stores the ad requests in the ad request store 116. For example, an ad request includes an advertisement, a bid price associated with the advertisement, and one or more targeting criteria identifying one or more characteristics of users eligible to be presented the advertisement, and an identifier associated with the ad request. In some embodiments, an ad request may also include one or more topics associated with the advertisement in the ad request by the advertiser 107, a location associated with the advertisement or any other suitable information. For example, an ad request received from a manufacturer may include an advertisement for a model, a bid amount of 5 cents per conversion, topic information identifying “cars” and “vehicles,” as well as and targeting criteria identifying users that are males between 20 and 25 years old and associated with a location in California.

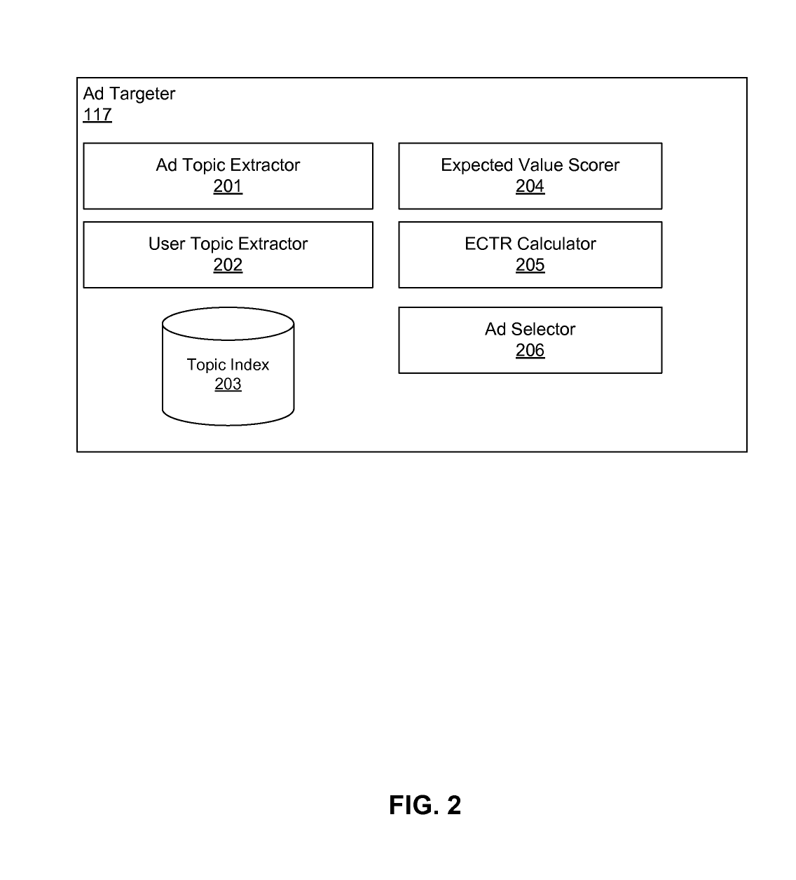

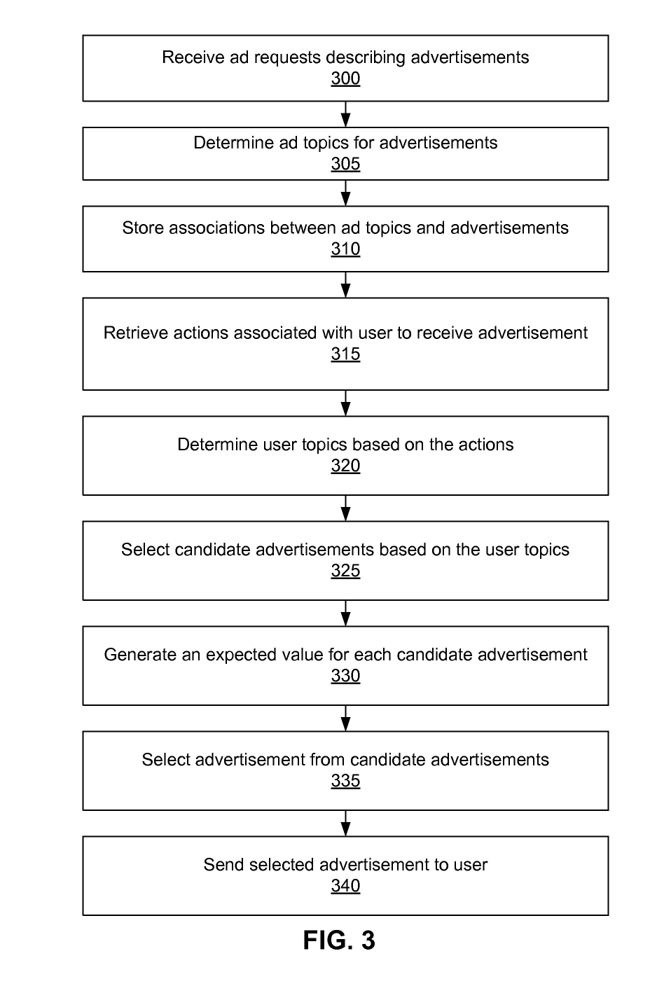

The ad targeter 117 retrieves information from the ad request store 116 and from the social aggregator 103 to select advertisements for presentation to a user. As further described below in conjunction with FIGS. 2 and 3, the ad targeter 117 identifies topics associated with ads from received ad requests and analyzes information associated with a user from the action store 104 (i.e. a user's actions) to associate topics with a user. Based on the topics associated with the user and the topics associated with the advertisements, the ad target 117 determines candidate advertisements associated with topics likely to be of interest to the user and selects an advertisement from the candidate advertisements. For example, the ad targeter 117 selects an advertisement for presentation to the user having a highest bid price or having a highest expected value to the social networking system.

FIG. 2 is a block diagram of one embodiment of the ad targeter 117. In the embodiment shown by FIG. 2, the ad targeter 117 comprises an ad topic extractor 201, a user topic extractor 202, a topic index 203, an expected value scorer 204, an expected click-through rate (ECTR) calculator 205, and an advertisement (“ad”) selector 206. In other embodiments, different and/or additional components may be included in the ad targeter 117.

The ad topic extractor 201 associates one or more ad topics with an ad identifying the subject matter of an ad. In one embodiment, the ad topics are determined from information in the ad request stored in the ad request store 116 and associated with the ad. For example, labels, tags, descriptions or other explicit information describing topics of an advertisement may be included in an ad request by an advertiser. Information from the ad store 118 maintained by the advertiser 107 may also be used to determine one or more ad topics for an ad. The ad topic extractor 201 may also identify additional topics associated with an ad related to, or similar to, topics previously associated with an ad. Additionally, the ad topic extractor 201 may analyze the content of the advertisement and/or the content of a landing page associated with the advertisement to identify one or more topics associated with the advertisement. In one embodiment, the ad topic extractor 201 identifies anchor terms included in the advertisement or in a landing page associated with the advertisement and determines the meaning of the anchor terms as further described in U.S. application Ser. No. 13/167,701, filed Jun. 24, 2011, and U.S. patent application Ser. No. 13/627,945, filed on Sep. 26, 2012, which are each hereby incorporated by reference in their entirety.

One or more topics associated with an advertisement by the ad topic extractor 201 are used to generate entries in the topic index 203 associating the one or more topics with an advertisement identifier. In one embodiment, the advertisement identifier is retrieved from the ad request associated with an advertisement. Alternatively, the ad module 114 associates a unique identifier with each received ad request. The topic index 203 allows efficient identification of advertisements associated with a specified topic by searching the topic index 203 for the specified topic and identifying advertisement identifiers associated with the specified topic. For example, to identify advertisements associated with the topic “auto sales,” entries in the ad index 203 including “auto sales” are identified and used to retrieve advertisements. In one embodiment, the topic index 203 may also include data identifying topics related to each other, allowing additional advertisements associated with entries specifying a topic related to a specified topic to be retrieved.

The user topic extractor 202 determines topics associated with a user based on actions associated with the user in the action store 104, user profile data from the user profile store 112, and other information from the social graph 113. For example, the user topic extractor 202 identifies anchor terms included in content items, such as text content, posted by the user within a specified time of the current time and determines the meaning of the anchor terms as further described in U.S. application Ser. No. 13/167,701, filed Jun. 24, 2011, and U.S. patent application Ser. No. 13/627,945, filed on Sep. 26, 2012, which are each hereby incorporated by reference in their entirety. In other embodiments, the user topic extractor 202 may apply natural language processing, machine-learned models, and/or concept extraction techniques to identify one or more topics from user actions, such as text content posted by the user. For example, if a user recently posts a message including the text, “Wish me luck, I'm off to look for a new car,” the user topic extractor 202 may extract a topic of “automobile sales” from the message.

Other types of actions may be used to determine a topic associated with a user. In one embodiment, characteristics of an action or on an object on which an action is performed may be used to identify a topic associated with the user performing the action. For example, if a user uploads music to be shared with other users, the user topic extractor 202 may use characteristics of the uploaded music (e.g., the artist information, genre information, or other information) to determine a topic. To illustrate, if a user uploads a song by a particular artist, the user topic extractor 202 may associate the artist as a topic for the user. Similarly, the user topic extractor 202 may determine topics based on content that the user expresses a preference for (“likes”), comments about, shares with other users, or performs any other suitable action with. Information associated with entities to which the user has a connection (e.g., profile pages) may also be used to identify one or more topics for the user. For example, an entity associated with an object which a user interacts with (e.g., connects to, expresses a preference for, comments on, shares, etc.) may be identified as a topic for the user or used to identify a topic for the user.

The expected value scorer 204 determines an expected value for advertisements indicating the expected compensation to the social networking system 108 for presenting the advertisement to a user. The expected value is based on a bid amount associated with the advertisement, and may also be based on the likelihood that the user accesses the advertisement if it is presented, which may be retrieved from the ECTR calculator 205. In one embodiment, the expected value is the bid amount of the advertisement. Alternatively, the expected value is a product of the bid amount and the likelihood the user accesses the advertisement. As described above, the bid amount is included in the ad request along with the advertisement and may be retrieved from the ad request store 116 or from the advertiser 107.

In one embodiment, the ECTR calculator 205 determines the likelihood that a user will access an advertisement presented to the user. The likelihood of the user accessing an advertisement is based on characteristics of the user and of the advertisements, so different users likely have different likelihoods of accessing the same advertisement. Ad topics associated with an advertisement and topics associated with the user may be used by the ECTR to determine the likelihood of the user accessing the advertisement. For example, the number of matches between ad topics and topics associated with the user may affect the likelihood the user accesses an ad (e.g., more matches may increase the likelihood the user accesses the ad, and vice versa). Other information about a user (e.g., prior advertisements accessed by a user) and stored in the action store 104 may be used to determine the likelihood of a user accessing an advertisement. The ECTR calculator 205 may apply one or more machine-learned models to determine likelihood of advertisement access, allowing the likelihood calculations to be modified over time as more user interactions are captured.

In one embodiment, the ECTR calculator 205 and expected value scorer 204 generate likelihoods of advertisement access and expected values for a set of candidate advertisements selected by the ad selector 206. The ad selector 206 selects a one or more candidate advertisements from the ad request store 116 and identifies the one or more candidate advertisements to the expected value scorer 204 and/or to the ECTR calculator 205 to determine the expected values of each of the candidate advertisements. The ad selector 206 selects the one or more candidate advertisements based in part on the topics associated with the user to be presented an advertisement and ad topics associated with the candidate advertisements. For example, the ad selector 206 selects advertisements from the ad request store 116 associated with at least a threshold number of ad topics matching, or related to, topics associated with the user. In another implementation the ad selector 206 selects advertisements having ad topics matching, or associated with, topics associated with actions performed by the user within a threshold time from the current time or topics most recently associated with the user. The ad selector 206 may reduce the use of a topic associated with the user for ad selection based on the difference between a current time and the time associated with the action from which the topic associated with the user was extracted. Determining user topics based on user actions, determining advertising topics based on advertising data, and selecting advertisements based on time-scaled user topics is further described in U.S. application Ser. No. 13/095,899, filed on Apr. 28, 2011, which is incorporated by reference herein in its entirety.

The ad selector 206 also accounts for targeting criteria associated with an advertisement when selecting the one or more candidate advertisements. Characteristics associated with the user are retrieved from the user profile store 112, the action logger 105 and/or the social graph 113 to determine if the user satisfies targeting criteria associated with an advertisement. If the user does not satisfy targeting criteria for an advertisement, the advertising is not selected as a candidate advertisement.

Based on the expected values associated with each of the candidate advertisements, the ad selector 206 selects an advertisement that is presented to a user. In one embodiment, the ad selector 206 ranks the candidate advertisements based on the expected values and selects the candidate advertisement having the highest expected value or having at least a threshold expected value. More than one candidate advertisement may be selected and presented to the use by the ad selector 206.

### Selecting an Advertisement for a User

FIG. 3 is a flow chart of one embodiment of a process for selecting an advertisement for display to a user. The ad module 114 receives 300 ad requests from advertisers 107 describing advertisements and additional information, as described above. The received ad requests are stored in the ad request store 116 and one or more ad topics are determined 305 for each advertisement by the ad topic extractor 201, as described above in conjunction with FIG. 2. Associations between each advertisement and the ad topics extracted from an advertisement are stored 310 in the topic index 203.

When an advertisement is to be presented to a user, the user topic extractor 202 retrieves 315 actions performed by the user from the action store 104 and determines 320 one or more topics associated with the user based on the actions. The retrieved actions may be associated with a specified time interval or may have occurred within a threshold time from a time when the advertisement is to be presented. This allows the user topic extractor 202 to identify topics most likely to be relevant to the user when the advertisement is to be presented.

Based on the topics associated with the user and the ad topics, the ad selector 207 selects 325 candidate advertisements. As described above in conjunction with FIG. 2, the candidate advertisements may be selected 325 by matching a threshold number of current user topics to advertisements in the topic index 203, or by choosing some predetermined number of candidate advertisements associated with ad topics matching topics associated with the user within a threshold time of a current time. Targeting criteria associated with the advertisements may also be used, so that the user satisfies one or more targeting criteria associated with each advertisement selected 325 as a candidate advertisement.

The expected value scorer 204 generates 330 an expected value score for each of the candidate advertisements. As described above, the expected value of a candidate advertisement is based on the bid amount associated with the candidate advertisement and may also be based on the likelihood that the user will access the candidate advertisement if it is presented. Based on the expected values, one or more advertisements are selected by the ad selector 206. One or more of the selected advertisements are sent 340 to a client device 100 associated with the user for presentation.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving advertising data describing a plurality of advertisements;
determining one or more ad topics associated with each of the plurality of advertisements;
generating a topic index that associates the plurality of advertisements with one or more ad topics associated with each advertisement;
receiving data describing one or more actions performed by a user of a social networking system;
determining one or more user topics based at least in part on the one or more actions;
selecting one or more candidate advertisements based on the one or more user topics and one or more ad topics associated with each of the one or more candidate advertisements according to the topic index;
generating an expected value for each of the one or more candidate advertisements;
selecting an advertisement from the one or more candidate advertisements based at least in part on the expected values; and
sending the targeted advertisement to a client device associated with the user for presentation to the user.

2. The method of claim 1, wherein determining one or more user topics based at least in part on the one or more actions comprises:
extracting one or more topics from text content provided to the social networking system by the user.

3. The method of claim 1, wherein determining one or more user topics based at least in part on the one or more actions comprises:
identifying one or more topics based on characteristics of one or more objects on which the user performs at least one action.

4. The method of claim 1, wherein determining one or more user topics based at least in part on the one or more actions comprises:
identifying one or more topics based on characteristics of the one or more actions.

5. The method of claim 1, wherein determining one or more user topics based at least in part on the one or more actions comprises:
determining times associated with one or more of the actions; and
determining one or more topics based on the one or more actions and based on the times associated with the one or more actions.

6. The method of claim 1, wherein determining one or more ad topics associated with each of the plurality of advertisements comprises:
determining an ad topic associated with an advertisement based on text data included in the advertisement.

7. The method of claim 1, wherein determining one or more ad topics associated with each of the plurality of advertisements comprises:
determining an ad topic associated with an advertisement based content retrieved from a landing page associated with the advertisement.

8. A method comprising:
receiving data describing one or more actions performed by a user of a social networking system within a threshold time from a current time;
determining one or more user topics based at least in part on the one or more actions;
selecting one or more candidate advertisements associated with at least a threshold number of ad topics matching at least one user topic according to a topic index, the topic index generated by associating a plurality of received advertisements with one or more ad topics determined to be associated with each advertisement;
generating an expected value for each of the one or more candidate advertisements;
selecting an advertisement from the one or more candidate advertisements based at least in part on the expected values; and
sending the targeted advertisement to a client device associated with the user for presentation to the user.

9. The method of claim 8, wherein determining one or more user topics based at least in part on the one or more actions comprises:
extracting one or more topics from text content provided to the social networking system by the user.

10. The method of claim 8, wherein determining one or more user topics based at least in part on the one or more actions comprises:
identifying one or more topics based on characteristics of one or more objects on which the user performs at least one action.

11. The method of claim 8, wherein determining one or more user topics based at least in part on the one or more actions comprises:
identifying one or more topics based on characteristics of the one or more actions.

12. The method of claim 8, wherein determining one or more user topics based at least in part on the one or more actions comprises:
determining times associated with one or more of the actions; and
determining one or more topics based on the one or more actions and based on the times associated with the one or more actions.

13. The method of claim 8, wherein determining one or more ad topics associated with each of the plurality of advertisements comprises:
determining an ad topic associated with an advertisement based on text data included in the advertisement.
